(19) United States
(12) Patent Application Publication
(10) Pub. No.: US 2018/0213139 A1
(43) Pub. Date: Jul. 26, 2018

(54) IMAGE PROCESSING APPARATUS AND METHOD

(71) Applicant: SONY CORPORATION, TOKYO (JP)

(72) Inventors: ATSUSHI ITO, KANAGAWA (JP); HIROSHI ORYOJI, KANAGAWA (JP); TOMOHIRO NISHI, TOKYO (JP)

(73) Assignee: SONY CORPORATION, TOKYO (JP)

(21) Appl. No.: 15/578,399

(22) PCT Filed: May 27, 2016
(86) PCT No.: PCT/JP2016/065677

§ 371 Date: Nov. 30, 2017

(30) Foreign Application Priority Data
Jun. 10, 2015 (JP) 2015-117624

(51) Int. Cl. H04N 5/235; H04N 5/262; G06T 1/00; G06T 11/60

(52) U.S. Cl. CPC H04N 5/2353; G06T 11/60; G06T 1/0007; H04N 5/2625

(57) ABSTRACT

The present technology relates to an image processing apparatus and method that can reduce a transmission delay of image data items. According to one aspect of the present technology, respective partial images of a plurality of captured images acquired by image capturing units different from each other are integrated and one composited image is generated. The exposure periods of the respective image capturing units may be the same or may be shifted from one another. The exposure periods of only a part of the capturing units may be shifted. The present technology can be applied to an image capturing device, an electronic device using the image capturing device, a computer, a system, or the like that processes the image data items acquired by the image capturing device, for example.

### TECHNICAL FIELD

The present technology relates to an image processing apparatus and method, more particularly to, an image processing apparatus and method that can reduce a transmission delay of image data items.

### BACKGROUND ART

In the related art, the technology of image capture with a high frame rate has been developed (see Patent Literature 1 and Patent Literature 2, for example). For example, Patent Literature 1 discloses a method of driving image sensors at a high speed to increase a frame rate higher than a normal frame rate. Also, for example, Patent Literature 2 discloses a method of using a plurality of image sensors driven at a normal frame rate and shifting driving timings of the image sensors from one another, to thereby realizing a high frame rate as a whole.

### CITATION LIST

### Patent Literature

### [Patent Literature 1] Japanese Patent No. 4503697

### [Patent Literature 2] United States Patent Application Publication No 2007/0030342

### DISCLOSURE OF INVENTION

### Technical Problem

However, in recent years, it is desirable to perform instantaneously (at real time) image processing on captured images with a high frame rate acquired by image sensors at a downstream processing system. In order to realize the instantaneous image processing, it is desirable to transmit the image data items acquired by the image sensors to the downstream processing system at a higher speed.

According to the technology disclosed in Patent Literature 1, in a case where the captured images have a high frame rate, a data rate of image data items obtained by photoelectric conversion is increased correspondingly. Therefore, it is desirable that the image data items be temporarily stored in a memory, etc., and transmitted to the outside. However, in this case, a significant transmission delay may be generated.

Further, according to the method disclosed in Patent Literature 2, a high frame rate may be realized by using the image sensors having the conventional performance. However, in order to sequentially transmit the image data items acquired by the respective image sensors to the downstream processing system, it is desirable that the image data items be temporarily stored in a memory, etc. and a timing be controlled to transmit the image data items. However, in this case, a significant transmission delay may be generated.

The present technology is made in view of the above-mentioned circumstances, and it is an object of the present technology to reduce the transmission delay of the image data items.

### Solution to Problem

One aspect of the present technology is an image processing apparatus including an image integration unit that integrates respective partial images of a plurality of captured images acquired by image capturing units different from each other and generates one composited image.

The image integration unit may integrate the partial images acquired by the image capturing units, the partial images being acquired in the same period shorter than an exposure time for one frame of the captured images.

The image integration unit may integrate the partial images for each time within the period.

Respective exposure periods of the image capturing units may be shifted from one another.

The respective exposure periods of the image capturing units may be shifted from one another for each predetermined time.

The predetermined time may be shorter than the exposure time for one frame of the captured images.

A length of the period of acquiring the partial images may be the predetermined time.

The predetermined time may be a time provided by dividing the exposure time for one frame of the captured images by the number of the partial images to be integrated by the image integration unit.

The image integration unit may integrate the plurality of partial images located at positions different from each other of the captured images.

The respective exposure periods of the image capturing units may be the same period.

The image integration unit may integrate the plurality of partial images located at the same position of the captured images.

The exposure periods of some of the image capturing units may be the same, and the exposure periods of the others may be shifted from one another.

The image integration unit may integrate the plurality of partial images located at the same position of the captured images with the partial image located at a position of the captured images, the position being different from the position of any of the plurality of partial images.

The image processing apparatus may further includes a position correction unit that corrects positions of the partial images in accordance with the positions of the image capturing units that acquire the partial images.

The image processing apparatus may further includes a chasing processor that performs chasing of a focused object in the composited image using the composited image generated by the image integration unit.

The image processing apparatus may further includes a processing execution unit that performs processing on control of an actuator unit that performs a predetermined physical motion using information on a chasing result of the focused object acquired by the chasing processor. according to.

The image processing apparatus may further includes a depth information generation unit that generates depth information about a depth of an object in the composited image using the composited image generated by the image integration unit.

The image processing apparatus may further includes a position correction unit that performs position correction on the depth information generated by the depth information generation unit in accordance with the position of the image capturing unit that acquires the depth information.

The image processing apparatus may further includes the plurality of image capturing units.

Other aspect of the present technology is an image processing method including integrating respective partial images of a plurality of captured images acquired by image capturing units different from each other; and generating one composited image.

According to the aspects of the present technology, the respective partial images of a plurality of captured images acquired by image capturing units different from each other are integrated and one composited image is generated.

### ADVANTAGEOUS EFFECTS OF INVENTION

According to the present technology, the images can be processed. In addition, according to the present technology, the transmission delay of the image data items can be reduced.

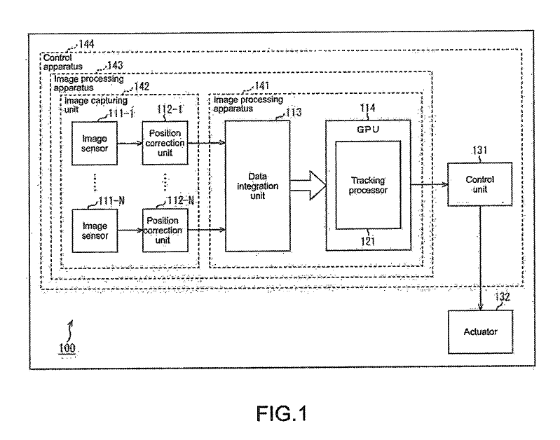

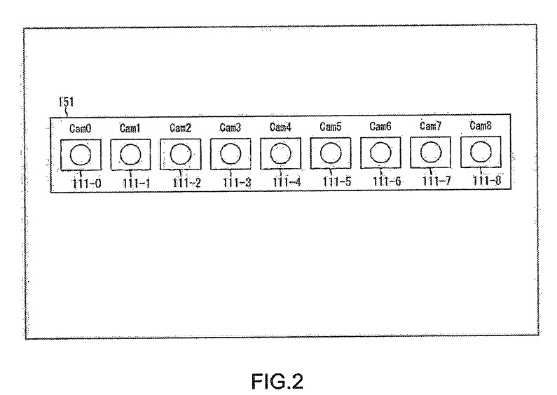

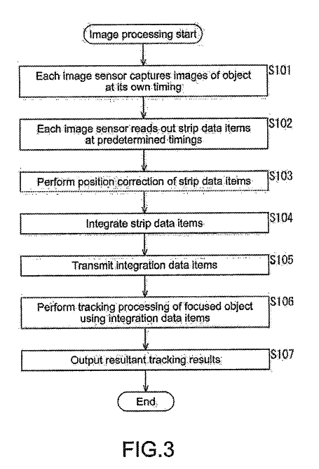

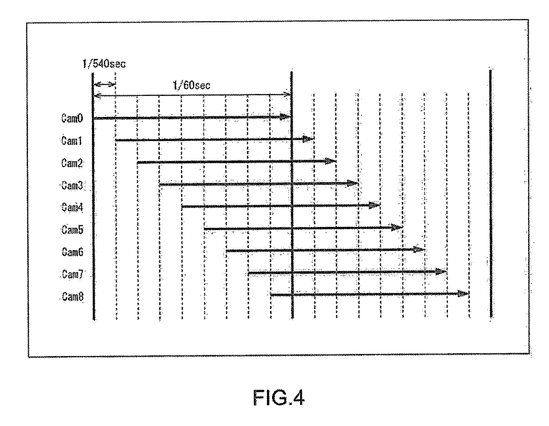

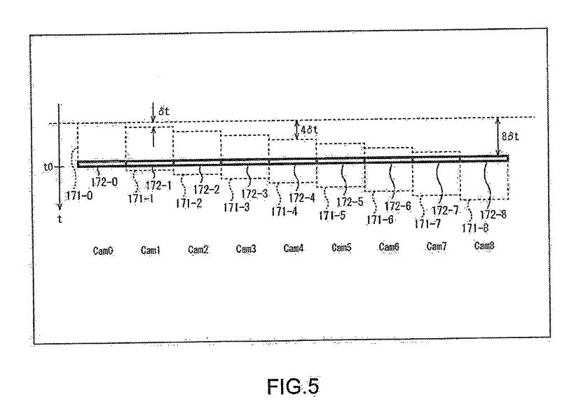

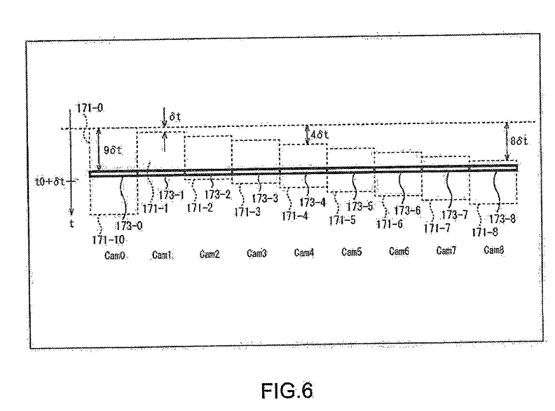

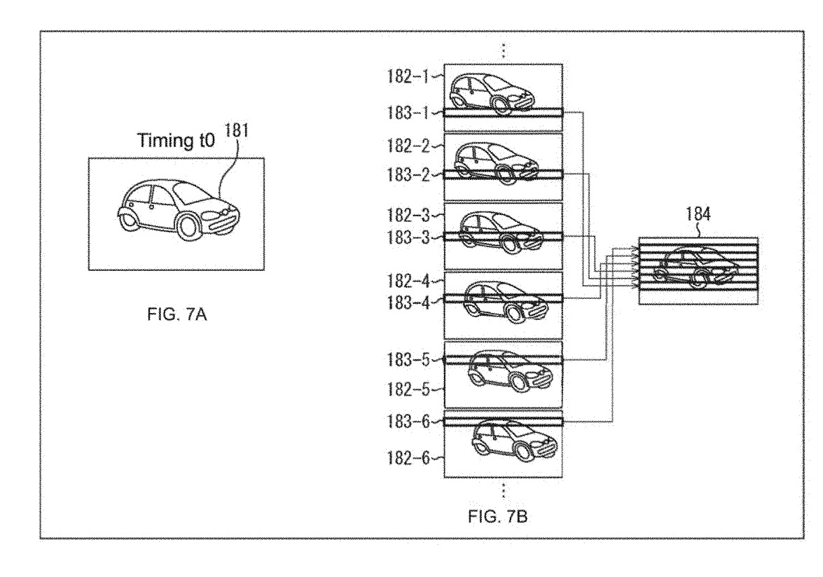

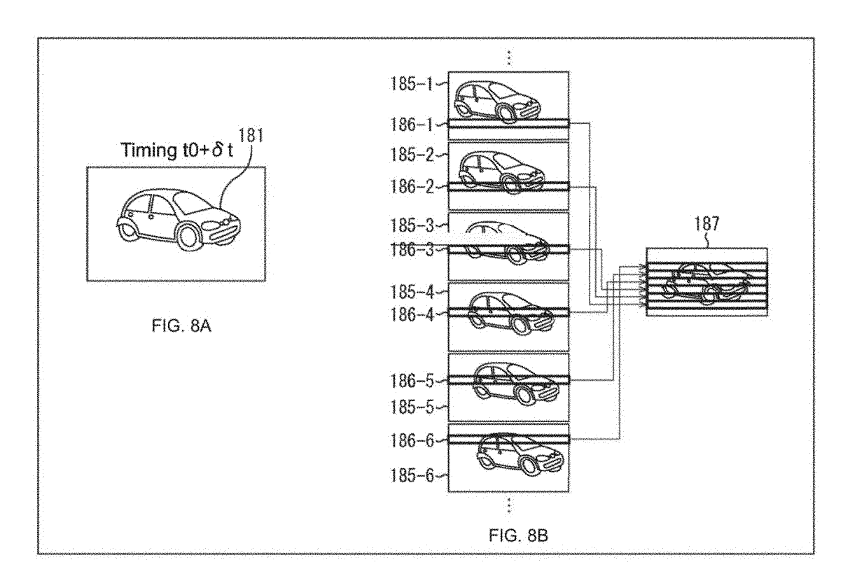

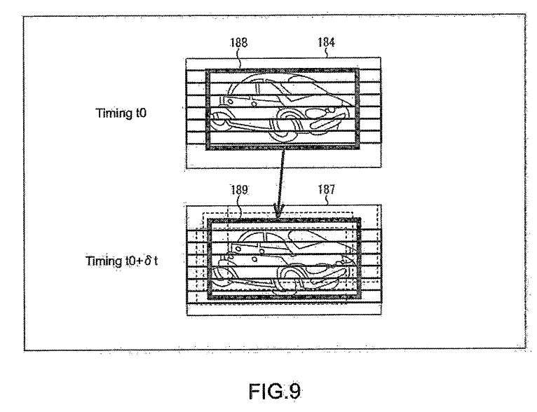

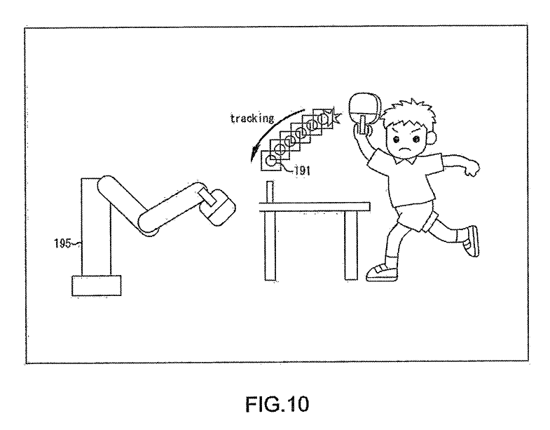

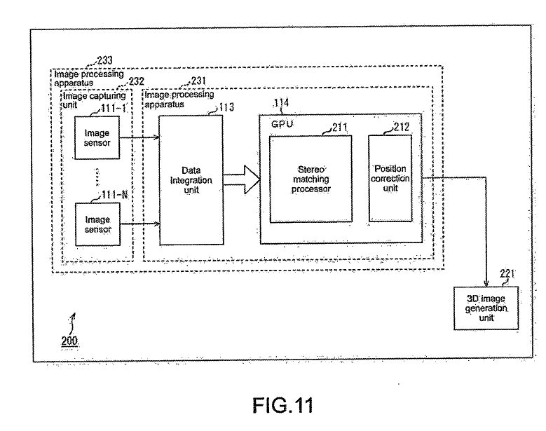

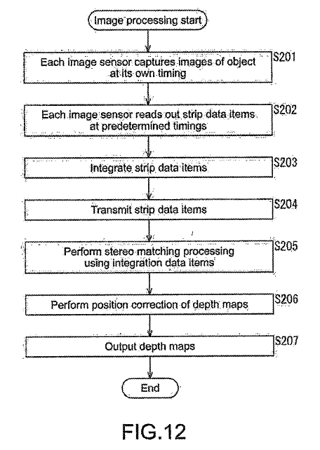

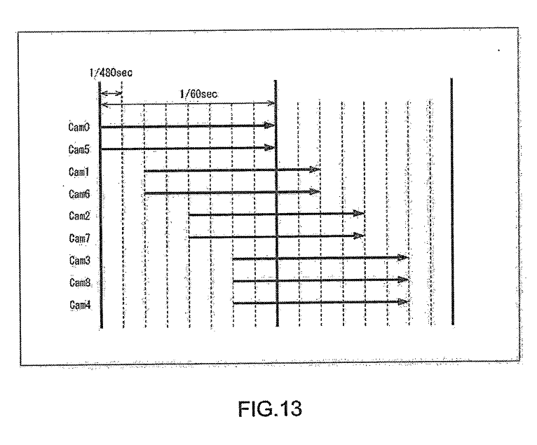

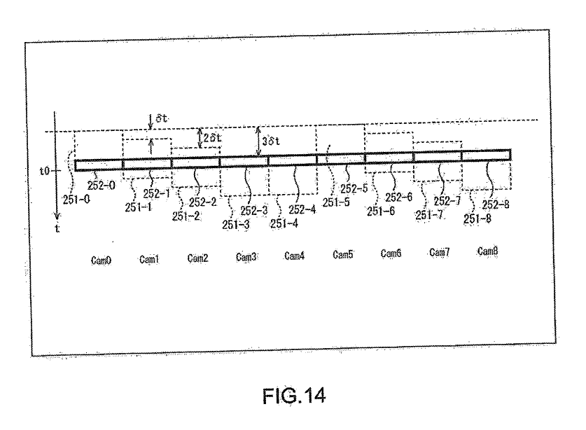

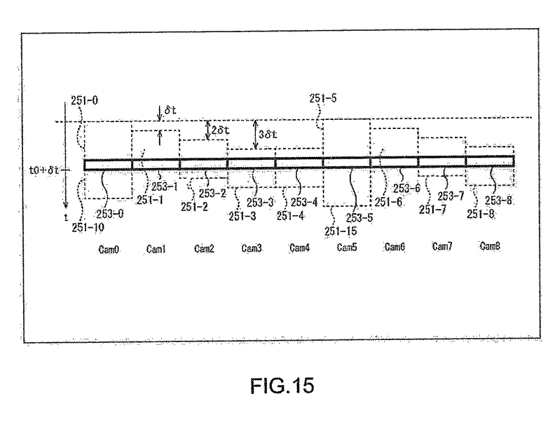

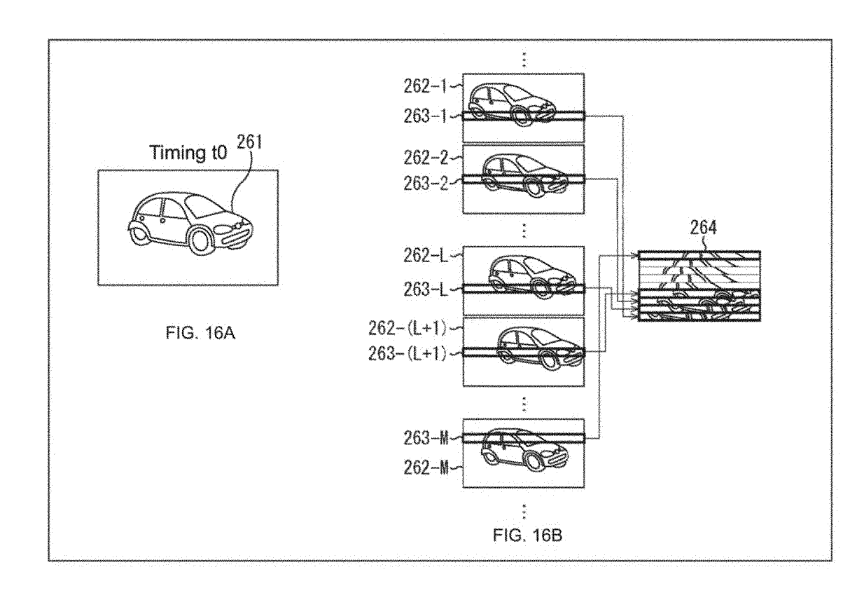

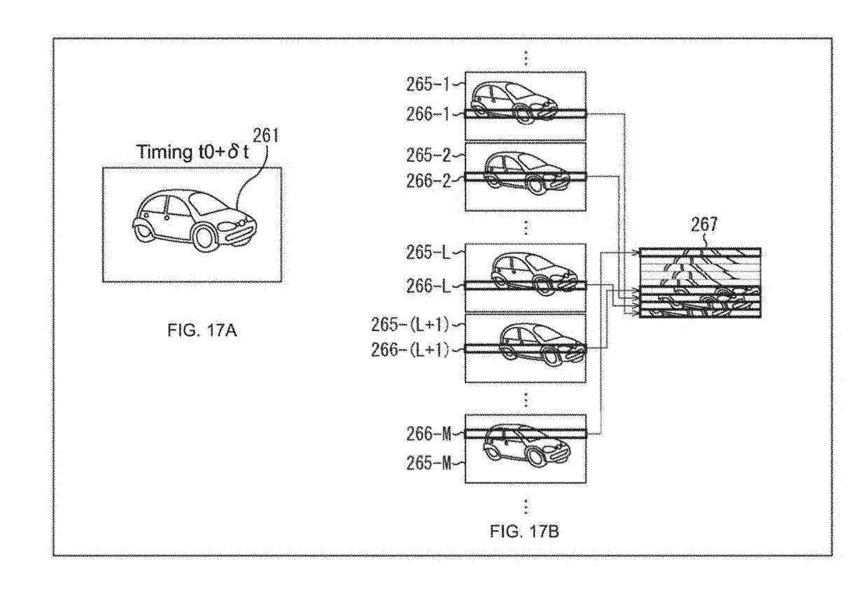

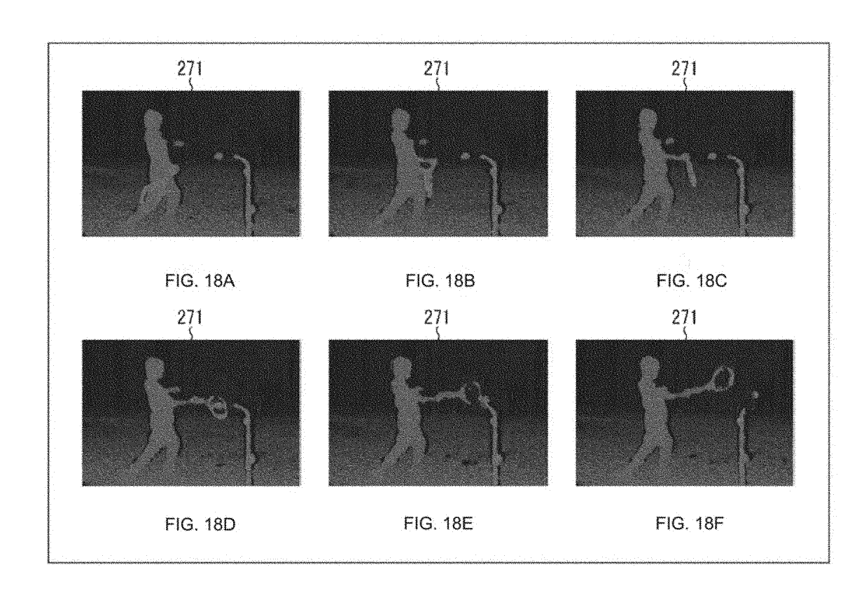

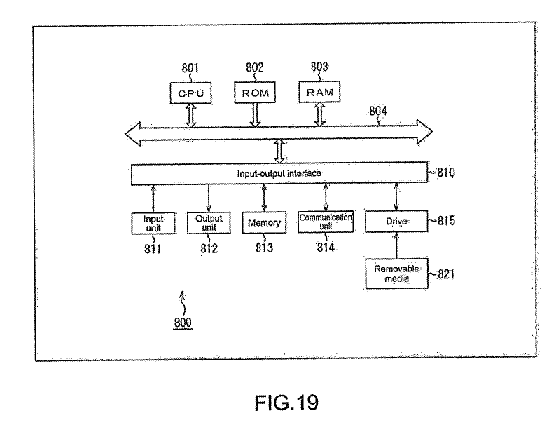

### BRIEF DESCRIPTION OF DRAWINGS

[FIG. 1] FIG. 1 is a block diagram showing a main configuration example of an image processing apparatus.

[FIG. 2] FIG. 2 is a diagram showing a main configuration example of an image capturing apparatus.

[FIG. 3] FIG. 3 is a flowchart of illustrating an example of image processing.

[FIG. 4] FIG. 4 is a diagram of illustrating an example of exposure periods of image data items.

[FIG. 5] FIG. 5 is a diagram of illustrating an example of reading out the image data items.

[FIG. 6] FIG. 6 is a diagram of illustrating an example of reading out the image data items.

[FIG. 7] FIG. 7 is a diagram of illustrating an example of integrating the image data items.

[FIG. 8] FIG. 8 is a diagram of illustrating an example of integrating the image data items.

[FIG. 9] FIG. 9 is a diagram of illustrating an example of tracking processing.

[FIG. 10] FIG. 10 is a diagram illustrating a usage example of the image processing.

[FIG. 11] FIG. 11 is a block diagram showing another configuration example of an image processing apparatus.

[FIG. 12] FIG. 12 is a flowchart of illustrating an example of image processing.

[FIG. 13] FIG. 13 is a diagram of illustrating an example of exposure periods of image data items.

[FIG. 14] FIG. 14 is a diagram of illustrating another example of reading out the image data items.

[FIG. 15] FIG. 15 is a diagram of illustrating another example of reading out the image data items.

[FIG. 16] FIG. 16 is a diagram of illustrating another example of integrating the image data items.

[FIG. 17] FIG. 17 is a diagram of illustrating another example of integrating the image data items.

[FIG. 18] FIG. 18 is a diagram showing an example of depth data items.

[FIG. 19] FIG. 19 is a block diagram showing a main configuration example of a computer.

### MODE(S) FOR CARRYING OUT THE INVENTION

Hereinafter, modes for carrying out the present disclosure (hereinafter referred to as embodiments) will be described. The embodiments will be described in the following order.

1. First embodiment (image processing apparatus)
2. Second embodiment (image processing apparatus)
3. Third embodiment (computer)

### 1. First Embodiment

<Instantaneous Image Processing of Image Data Items with High Frame Rate>
In the related art, a technology of capturing images with a high frame rate has been developed. For example, according to one method, one image sensor is driven at a high speed to realize a frame rate higher than a normal frame rate. According to another method, a plurality of image sensors, each of which is driven at a normal frame rate, are used and driving timings thereof are shifted from one another to realize a high frame rate as a whole, for example.

In a case where the captured images have a high frame rate, a data rate of image data items obtained by photoelectric conversion is increased correspondingly. Therefore, it becomes difficult to transmit instantaneously (at real time) the image data items from the image sensor to the outside and to perform image processing on the image data items. Accordingly, in general, the image data items are temporarily stored in a memory, etc., and transmission to the outside and the image processing are often performed at non-real time as so-called offline processing.

However, in recent years, it is desirable to perform instantaneously (at real time) the image processing on captured images with a high frame rate acquired by an image sensor by a downstream processing system. For example, in a case where the captured images are analyzed and the analyzed result is used for device control, a time lag from the image capture to the image processing results in a delay of control. Therefore, the less the time lag is, the more it is desirable. As described above, in a case where the image data items are temporarily stored in a memory, a time lag from the image capture to the image processing is increased. It may be difficult to realize instantaneous image processing.

In order to realize the instantaneous image processing on the image data items with a high frame rate (i.e., in order to perform the image processing as the real-time processing), it is desirable to increase a processing speed of the image processing for preventing an overflow of data, and to transmit the image data items acquired by the image sensor to the downstream processing system at real-time processing (instantaneously) for preventing an underflow of data.

For this purpose, for example, in a case of the method of driving one image sensor at a high speed to realize the high frame rate, the speed of entire processing by the image sensor may be increased from reading out of the image data items from a photoelectric conversion device to transmission the image data items to the outside. However, in this case, power consumption of the image sensor may be increased. In addition, a high-spec image sensor is required to realize high-speed processing from the capture to the transmission. Therefore, the costs of developing and manufacturing the image sensor may be increased.

In contrast, in a case of the method of shifting driving timings of a plurality of image sensors driven at a normal frame rate one another to realize a high frame rate as a whole, the high frame rate can be realized by the image sensors having the conventional performance, and the image data items can be outputted to the outside of the image sensor. However, in this case, the plurality of image data items are transmitted in parallel. Specifically, the downstream processing system has to receive and process the plurality of image data items transmitted in parallel. Such a technology is not conceived, and it is hard to realize. Even if it is realized, one or more frames of the image data items have to be received before staring the image processing. Accordingly, respective received image data items have to be held in a memory, and a time lag for one or more frames may occur.
<Integration of Partial Images>
Hence, respective partial images of a plurality of captured images acquired by image capturing units different from each other are integrated, and one composited image is generated.

For example, an image processing apparatus includes an image integration unit that integrates the respective partial images of the plurality of captured images acquired by the image capturing units different from each other and generates the one composited image.

Since the images are integrated in this way, a configuration of a bus or the like that transmits the image data items may be simple, and it is only necessary for a downstream image processor to process a set of image items. Thus, the real-time processing (i.e., instantaneous image processing) is easily realized. In addition, since the partial images are integrated, the image processing may be started without waiting a time for one or more frames. In other words, an increase of the time lag of the image processing is inhibited. In other words, by applying the present technology, the transmission delay of the image data items can be reduced, while increases of the costs and the power consumption are inhibited.
<Image Processing Apparatus>
FIG. 1 is a diagram showing a main configuration example of an image processing apparatus that is an embodiment of an image processing apparatus to which the present technology is applied.

In FIG. 1, an image processing apparatus 100 is an apparatus that generates captured images with a high frame rate and performs image processing instantaneously (at real time) on the captured images (performs image processing as real-time processing).

Note that a specific numerical value of a frame rate of the image data items processed by the image processing apparatus 100 is arbitrary. As described later, the image processing apparatus 100 captures images by using a plurality of image sensors, and generates the image data items with a frame rate higher than a frame rate of each image sensor. In other words, in the description of this specification, the frame rate of each image sensor (the highest frame rate, in a case where frame rates are different) will be referred to as a standard frame rate, and a frame rate higher than the standard frame rate will be referred to as a high frame rate.

As shown in FIG. 1, the image processing apparatus 100 includes an image sensor 111-1 to an image sensor 111-N (N is an integer of 2 or more), a position correction unit 112-1 to a position correction unit 112-N, a data integration unit 113, and a GPU (Graphics Processing Unit) 114.

In the following description, in a case where there is no need to distinguish the image sensor 111-1 to the image sensor 111-N from one another, it may also be collectively referred to as image sensors 111. Also, in a case where there is no need to distinguish the position correction unit 112-1 to the position correction unit 112-N from one another, it may also be collectively referred to as position correction units 112.

The image sensors 111 capture images of an object, photoelectrically convert light from the object, and generate image data items of the captured images. Each image sensor 111 is a CMOS (Complementary Metal Oxide Semiconductor) sensor, and reads out image data items from a pixel array for one line to several lines with a light exposure sequentially reading out method (also referred to as a rolling shutter method). The image sensors 111 supply the position correction units 112 with the generated image data items.

The position correction units 112 correct displacements among the captured images caused by positional differences of the respective image sensors 111 for the image data items generated by the image sensors 111 corresponding to the position correction units 112. The respective position correction units 112 supply the data integration unit 113 with the position-corrected image data items.

The data integration unit 113 integrates the image data items supplied from the respective position correction units 112. Specifically, the data integration unit 113 integrates the image data items (of the partial images) of the captured images acquired by the respective image sensors 111. The data integration unit 113 supplies the GPU 114 with the integrated image data items as a set of image data items.

The GPU 114 performs image processing on a set of image data items supplied from the data integration unit 113 instantaneously (at real time). The GPU 114 executes a program and the like and processes data, to thereby realize a function about the image processing. A tracking processor 121 of FIG. 1 is a functional block of the function that is realized by the GPU 114.

The tracking processor 121 performs chasing processing (also referred to as tracking processing) of detecting a movement of a predetermined object-being-chased within the captured images included in the images of the image data items (i.e., captured images) supplied from the data integration unit 113, and chasing the object.

The GPU 114 outputs information indicating the result of the chasing processing by the tracking processor 121. For example, the image processing apparatus 100 further includes a control unit 131 and an actuator 132. The GPU 114 supplies the control unit 131 with the information indicating the result of the chasing processing.

The control unit 131 generates control information that controls the actuator 132 on the basis of the information indicating the result of the chasing processing supplied from the GPU 114. The control unit 131 supplies the actuator 132 with the control information at an adequate timing.

The actuator 132 converts electric energy into a physical motion and drives physical mechanisms such as mechanical elements on the basis of control signals supplied from the control unit 131.
<Arrangement Example of Image Sensor>
FIG. 2 shows an arrangement example of the image sensors 111. In the following description, as shown in FIG. 2, nine image sensors 111 (image sensor 111-0 to image sensor 111-8) are arranged in one line at a predetermined distance in a horizontal direction. In other words, the data integration unit 113 integrates the partial images of the captured images acquired by the respective nine image sensors 111. Note that the image sensor 111-0 to image sensor 111-9 are also referred to as Cam0 to Cam8. Also, in a case where there is no need to distinguish the Cam0 to the Cam8 from one another, it may also be collectively referred to as Cams (i.e., the image sensors 111).
   <Flow of Image Processing>
An example of a flow of the image processing executed by the image processing apparatus 100 of FIG. 1 will be described with reference to a flowchart of FIG. 3. As necessary, it will be described with reference to FIG. 4 to FIG. 9.

Once the image processing apparatus 100 starts the image processing, each image sensor 111 captures images of an object at its own timing in Step S101.

FIG. 4 shows an example of exposure periods (periods of exposure) (in other words, image capturing timings) of the respective image sensors 111. Each arrow in FIG. 4 shows the exposure period of the corresponding Cam. Note that the period of no exposure does not exist in the description for simplicity. In this case, a frame rate of each image sensor 111 is 60 fps, and an exposure time (length of exposure period) for one frame of the captured images is 1/60 sec. In addition, the exposure periods of the respective image sensors are shifted by 1/540 sec.

Thus, the exposure periods of the respective image sensors 111 may be shifted from one another. For example, the exposure periods of the respective image sensors 111 may be shifted by a predetermined time one another. For example, the exposure periods of the respective image sensors 111 may be shifted from one another by a predetermined time shorter than the exposure time (length of exposure period) for one frame of the captured images. For example, the predetermined time may be a time (in the example of FIG. 4, “ 1/540 sec”) provided by dividing the exposure time for one frame of the captured images (in the example of FIG. 4, “ 1/60 sec”) by the number of the partial images to be integrated (i.e., the number of the image sensors 111 (in the example of FIG. 4, “9”)). It should be appreciated that the example of FIG. 4 is illustrative, and a value of each parameter such as the exposure period, the frame rate, the number of the image sensors 111, and the length of the exposure period shifted between the image sensors 111 (predetermined time) may be other than the value of the example of FIG. 4.

With reference to FIG. 3 again, in Step S102, each image sensor 111 reads out the partial images (strip data items) of the captured images to the outside of the image sensor 111 at predetermined timings.

It is sufficient that the length of the exposure time of acquiring the partial images (strip data items) is shorter than the predetermined time. Also, the length of the exposure time of acquiring the partial images (strip data items) is shorter than the exposure time for one frame of the captured images. Accordingly, the predetermined time (time interval of a timing to read out the partial images (strip data items)) may be shorter than the exposure time for one frame of the captured images. For example, the partial images (strip data items) may be read out for each time of the exposure period shifted between the respective image sensors 111. For example, the partial images (strip data items) may be read out at the start times of the exposure periods of the respective image sensors 111.

For example, in a case where the exposure periods of the respective image sensors 111 are shifted by 1/540 sec (predetermined time) one another as shown in FIG. 4, the 1/540 sec may be the time interval of the timing to read out the partial images (strip data items). Also, the 1/540 sec may be the exposure time of acquiring the partial images of the captured images.

As described above, the image data items (strip data items) are read out from the respective image sensors 111 for each period. In other words, the image data items (strip data items) are read out from the respective image sensors 111 at the same timing. The image data items (strip data items) are acquired in the same period shorter than an exposure time for one frame of the captured images.

Since the image sensors 111 read out the image data items by using the rolling shutter method as described above, the partial image (strip data item) is an image of partial lines (one line or plurality of continuous lines) out of all lines for one frame of the captured images. Also, the partial images (strip data items) read out from the respective image sensors 111 at the same timing may be the images located at positions (lines) different from each other for one frame of the captured images.

For example, in the case of FIG. 4, the exposure timings of the respective image sensors 111 are shifted by every 1/540 sec one another. The partial images (strip data items) are read out at the start times of the exposure periods of the respective image sensors 111, and 1/540 sec is the exposure time of acquiring the partial images (strip data items) of the captured images. Thus, the partial images (strip data items) read out from the respective image sensors 111 at the predetermined timings are the images located at positions (lines) different from each other for one frame of the captured images. The number of lines of a strip data item read out at one time may be the number of lines provided by dividing the number of lines of one frame of the whole one frame of the captured images by the number of the image sensors 111.

An example of reading out the strip data items at the predetermined timing t0 is shown in FIG. 5. In FIG. 5, a time axis is shown in the vertical direction (from top to bottom). In addition, a captured image 171-0 to a captured image 171-8 shown by dotted lines respectively represent the periods during which the image data items of the one frame of the captured images are read from the respective image sensors 111 (Cam0 to Cam8). In the following, in a case where there is no need to distinguish the captured image 171-0 to the captured image 171-8 from one another, it may be collectively referred to as captured images 171.

As shown in FIG. 5, read-out periods of the one frame of captured images 171 from the respective image sensors 111 are shifted by δt (in the example of FIG. 4, δt= 1/540 sec) one another. In addition, a strip data item 172-0 to a strip data item 172-8 are read out from the respective image sensors 111 at the predetermined timing to. In the following, in a case where there is no need to distinguish the strip data item 172-0 to the strip data item 172-8 from one another, it may be collectively referred to as strip data items 172.

Since the respective strip data items 172 are data acquired in the same period, the positions of the strip data items 172 with respect to the respective captured images 171 are different for each image sensor 111, as shown in FIG. 5. In other words, data items of lines different from each other are acquired at the same timing. In the example of FIG. 5, the image data items (strip data items) of the number of lines for one frame are read out from all the image sensors 111.

FIG. 6 shows an example of reading out the strip data items at next reading-out timing t0+δt. Also in FIG. 6, a time axis is shown in the vertical direction (from top to bottom) similar to FIG. 5.

At the timing t0+δt (FIG. 6), next strip data items are read out. Specifically, the image data items acquired during the period from the timing t0 for the time δt are read out as the strip data items. In the case of the Cam0, since the last strip data item of the frame is read out at the timing t0 (FIG. 5), the first strip data item 173-0 of the next frame of the captured image 171-10 is read out at the timing t0+δt (FIG. 6).

Also in the case of the timing t0+δt, the data items of lines different from each other are acquired from the respective image sensors 111. Specifically, in the example of FIG. 6, the image data items (strip data items) of the number of lines for one frame are read out from all the image sensors 111. Specifically, the image data items (strip data items) of the number of lines for one frame are read out from all the image sensors 111 for each predetermined period δt.

With reference to FIG. 3 again, in Step S103, the position correction units 112 perform position correction of the strip data items acquired by the image sensors 111 corresponding to the position correction units 112.

As described with reference to FIG. 2, since the positions of the respective image sensors 111 are different from each other, the image capturing ranges are shifted from one another. Accordingly, in a case where all the image sensors 111 capture images of the same object, for example, the positions of the object in the respective captured images are shifted from one another. The position correction units 112 perform the position correction of the images such that the displacements among the captured images (strip data items) are reduced.

For example, in the case of FIG. 2, since the image sensors 111 are arranged in one line in the horizontal direction, the position correction units 112 correct the displacements in the horizontal direction.

Note that the position correction is performed on the basis of the relative positional relationships of the image sensors 111. Thus, the position correction units 112 may identify the positional relationships in advance.

In Step S104, the data integration unit 113 integrates a strip data item group acquired by the respective image sensors 111 at the same timing (i.e., acquired by the processing in Step S102) on which the position correction is performed on the basis of the relative positional relationships of the image sensors 111 (i.e., position correction by the processing in Step S103). In other words, the data integration unit 113 may integrate the partial images (strip data items) acquired in the same period shorter than an exposure time for one frame of the captured images. Also, the data integration unit 113 may integrate the partial images (strip data items) for each time within the period. Furthermore, the image integration unit 113 may integrate the plurality of partial images located at positions different from each other of the captured images.

An example of integrating the strip data items read out at the predetermined timing t0 is shown in FIG. 7. For example, as shown in A of FIG. 7, images of an object 181 of an automobile are captured using the respective image sensors 111 at the timing to. As shown in B of FIG. 7, a captured image 182-1 to a captured image 182-6 are acquired by six image sensors 111 different from each other. In the following, in a case where there is no need to distinguish the captured image 182-1 to the captured image 182-6 from one another, it may be collectively referred to as captured images 182.

In addition, a strip data item 183-1 to a strip data item 183-6 are acquired from the image sensors 111 at the timing to. In the following, in a case where there is no need to distinguish the strip data item 183-1 to the strip data item 183-6 from one another, it may be collectively referred to as strip data items 183.

Depending on the positional relationship between the image sensors 111, the positions of the object 181 (automobile) are shifted from one another in the respective captured images 182 (i.e., respective strip data items 183). After the position correction units 112 perform the position correction on these strip data items 183, the data integration unit 113 integrates these strip data items 183 to provide a set of image data items.

The data integration unit 113 arranges the respective strip data items 183 on which the position correction is performed corresponding to their positional relationships in the line, and generates a set of the integration data items 184. In the examples described with reference to FIG. 4 to FIG. 6, since the image data items (strip data items) of the number of lines for one frame are read out for the predetermined period δt as described above, the integration data items 184 are the image data items for one frame. In other words, the captured images for one frame at the timing t0 are acquired.

In addition, an example of integrating the strip data items read out at the next timing t0+δt is shown in FIG. 8. For example, as shown in A of FIG. 8, images of the object 181 of the automobile are captured using the respective image sensors 111 at the timing t0+δt. As shown in B of FIG. 8, a captured image 185-1 to a captured image 185-6 are acquired by the six image sensors 111 different from each other. In the following, in a case where there is no need to distinguish from the captured image 185-1 to the captured image 185-6 from one another, it may be collectively referred to as captured images 185.

In addition, at the timing t0+δt, a strip data item 186-1 to a strip data item 186-6 are acquired from these image sensors 111. In the following, in a case where there is no need to distinguish the strip data item 186-1 to the strip data item 186-6 from one another, it may be collectively referred to as strip data items 186.

Also in this case, the data integration unit 113 arranges the respective strip data items 186 on which the position correction is performed corresponding to their positional relationships in the line, and generates a set of the integration data items 187. In other words, in the examples described with reference to FIG. 4 to FIG. 6, the integration data items 187 are the image data items for one frame. In other words, the captured images for one frame at the timing t0+δt are acquired.

Since the strip data items are integrated by the data integration unit 113 in this way, the integration data items (one frame of image data items) are acquired for each period δt.

With reference to FIG. 3 again, in Step S105, the data integration unit 113 transmits the integration data items to the GPU 114.

In other words, the GPU 114 acquires a set of captured images each having a frame rate (in the examples of FIG. 4 to FIG. 6, 540 fps) higher than the frame rate (standard frame rate) of each image sensor 111.

Accordingly, the GPU 114 may perform the desired image processing using the respective integration data items at the processing speed to match with the high frame rate. Specifically, since the GPU 114 has no need to perform complex processing including aligning and processing a plurality of image data items supplied in parallel and processing a plurality of image data items in parallel, increases of the time lag and the power consumption are inhibited. Also, an increase of development and production costs is inhibited.

Note that each image sensor 111 reads out the image data items by the rolling shutter method. As a matter of fact, the shape of the object 181 in the captured images (strip data items) is thereby distorted. Accordingly, one frame of the captured images is logically acquired at the timing t0 as the integration data items 184. As a matter of fact, possible distortions and displacements may remain in the images as shown in the integration data items 184 of FIG. 7 and the integration data items 187 of FIG. 8.

However, by performing the position correction by the position correction units 112 taking distortions and the like into consideration, displacements and distortions can be decreased. In other words, there can be provided the integration data items of the images substantially similar to the captured images.

In Step S106, the tracking processor 121 of GPU 114 performs tracking processing of the focused object included in the integration data items as the image processing using the supplied integration data items.

An example of the tracking processing is shown in FIG. 9. For example, in a case where the automobile (object 181) of FIG. 7 and FIG. 8 is the focused object, the tracking processor 121 specifies an area including the focused object 188 of the integration data items 184 at the timing t0, and specifies an area including the focused object 189 of the integration data items 187 at the timing t0+δt. For example, the tracking processor 121 specifies the area 189 having the image similar to the area 188 using a movement prediction method or the like. Thus, the tracking processor 121 specifies the areas including the focused object of the respective integration data items.

With reference to FIG. 3 again, in Step S107, the GPU 114 outputs the resultant tracking results (for example, information about the areas including the focused object) to the control unit 131.

The control unit 131 controls the actuator 132 in accordance with the tracking results. The actuator 132 drives the physical mechanisms such as machines on the basis of control of the control unit 131.

After each processing is performed as described above, the image processing is ended. Note that the above-described each processing in Step S101 to Step S107 is repeated for each period δt. Specifically, each processing is executed in parallel. After the image capture is ended, each processing is ended.

As described above, the image processing apparatus 100 can realize the image capture with a high frame rate by using the plurality of inexpensive image sensors 111 with low power consumption and a low frame rate (standard frame rate). Accordingly, the image processing apparatus 100 can realize the image capture with a high frame rate while increases of the costs and the power consumption are inhibited. In addition, by integrating strip data items acquired at the same timing as described above, the image processing apparatus 100 can reduce the transmission delay of the image data items while increases of the costs and the power consumption are inhibited. In this manner, the image processing apparatus 100 can realize the instantaneous image processing of the image data items while increases of the costs and the power consumption are inhibited.
<Usage Example of Tracking Processing>
By the tracking processing using the image data items with a high frame rate as described above, the tracking processing having a high chasing performance will be possible. In other words, the object-being-chased moving at a high speed can be chased more precisely.

For example, as illustrated in FIG. 10, the tracking processing is performed on a moving object, i.e., a ball 191 being as the object-being-chased. Using the tracking results, the robot 195 is controlled such that the robot 195 performs a proper motion on the ball 191. For example, as shown in FIG. 10, when a person hits a table tennis ball 191 toward the robot 195, the image processing apparatus 100 tracks the ball 191, and enables the robot 195 to properly return the ball 191 (return the ball 191 to an opponent side of a table-tennis table). At this time, since the tracking processing can be performed using the captured images with a substantially high frame rate as described above, the image processing apparatus 100 can properly tracks the ball 191 even if the ball 191 moves at a high speed, which enables the robot 195 to perform the proper motion.

### Other examples

Note that the present technology is not limited to the above-described examples. For example, the configuration of the apparatus to which the present technology is applied is not limited to the configuration of the image processing apparatus 100 of FIG. 1. It is only necessary for an apparatus to which the present technology is applied to have the data integration unit 113 of FIG. 1, and other configurations may be configured as other apparatuses. Also, one image processing apparatus 141 may include the data integration unit 113 and the GPU 114, for example. In this case, one image capturing apparatus 142 may include the image sensors 111 and the position correction units 112. Alternatively, one apparatus may include the respective image sensors 111, and one apparatus may include the respective position correction units 112.

In addition, one image processing apparatus 143 may include the image processing apparatus 141 and the image capturing apparatus 142. Furthermore, one control apparatus 144 may include the image processing apparatus 143 and the control unit 131.

The image sensors 111 may have any frame rate. In the above description, the respective image sensors 111 have the same frame rate. However, the frame rates of at least a part of the image sensors 111 may be different from (may not be the same as) the frame rates of at least other parts of the image sensors 111.

Similarly, the number of the pixels of the image sensors 111 is arbitrary and may be the same or not for all the image sensors 111. In addition, the arrangement of the pixels is arbitrary. For example, the respective pixels may be arrayed in an array or others such as honeycomb other than the array. Also, the arrangement of the respective pixels may be the same or not for all the image sensors 111.

In addition, the number of the image sensors 111 is arbitrary as long as a plurality of image sensors 111 are provided. Furthermore, the image sensors 111 may be CCDs (Charge Coupled Devices). Still further, a method of reading out the image data items of each image sensor 111 may not be the rolling shutter method. For example, the method may be a global shutter method. The method may be the same or not for all the image sensors 111.

In addition, it is sufficient that the strip data items may be the image data items of the partial images of the captured images. For example, the number of the strip data items is arbitrary. In other words, intervals of the reading-out timings of the strip data items are arbitrary. For example, the intervals of the reading-out timings of the strip data items may be the same as or not the same as the intervals of the reading-out timings of the rolling shutter method.

In addition, the number of lines of the strip data items read out at the respective timings may be always the same or not. Also, the number of lines of the strip data items read out at the respective timings by all the image sensors 111 may be the same or not. In other words, the interval (δt) of reading-out may be always uniform or variable. The interval may be the same or not for all the image sensors 111.

In addition, the shapes of the strip data items (i.e., shapes of partial images) are arbitrary. For example, the strip data items may include the image data items for column units, or may include the image data items for block unit such as macro blocks.

In addition, parts of the plurality of strip data items of one image sensor 111 may be overlapped one another.

The method of the arrangement of the image sensors 111 is arbitrary. The image sensors 111 may be arranged linearly, curvilineary, planarly, or curved in an arbitrary direction. Also, the respective image sensors 111 may be arranged at regular intervals or irregular intervals.

Note that the position correction units 112 may be omitted. In particular, in a case where the GPU 114 performs no image processing over the plurality of strip data items, no position correction is necessary, and the position correction units 112 may be omitted. Also, the position correction may be performed after the data items are integrated.

Note that the direction of correcting the displacements may be an arbitrary direction corresponding to the positional relationships of the image sensors 111, and is not limited to the above-described horizontal direction.

In addition, the data integration unit 113 may integrate only a part of the strip data items. Furthermore, the data integration unit 113 may change the strip data items to be integrated corresponding to the timing. Also, the integration data items may not be less than the captured images for one frame.

For example, in the example of FIG. 4, at the time of starting the image capture by the Cam0, the image capture by other Cams is not started. Accordingly, the integration data items do not form the image data items for one frame. However, as the integration data items can be transmitted to the GPU 114, the image processing can be started. Accordingly, the delay of the image processing can be reduced. For example, in a case where the tracking processing is performed as the image processing, the tracking processing having a high chasing performance will be possible. In other words, the object-being-chased moving at a higher speed can be chased more precisely.

Note that the image processing executed by the GPU 114 is arbitrary, and may be other than the tracking processing. For example, the image processing may include encoding and decoding. However, since the integration data items are aggregations of the strip data items, displacements, distortions, and the like are easily generated, as described above. So in most cases, processing of inhibiting an image quality degradation may be necessary in a case where the integration data items are used as viewing data items.

In addition, the control unit 131 may perform not only the control of the actuator 132 (actuator unit) but also arbitrary processing. Furthermore, the actuator 132 may be any actuator unit that performs any physical motion.

### 2. Second Embodiment

### <Image Processing Apparatus>

For another example of the image processing, the GPU 114 may perform stereo matching processing to generate depth maps (also referred to as depth information) including information about a depth for each position in the image capturing ranges from stereo images of a plurality of images having mutual parallaxes, for example. In this case, the exposure periods of some of the image sensors 111 may be the same, and the exposure periods of the others may be shifted from one another, for example. In other words, the data integration unit 113 may integrate the plurality of strip data items located at the same position of the captured images with the strip data items located at a position of the captured images, the position being different from the position of any of the plurality of strip data items.

FIG. 11 is a diagram showing a main configuration example of an image processing apparatus that is another embodiment of an image processing apparatus to which the present technology is applied.

In FIG. 11, an image processing apparatus 200 is an apparatus that generates captured images with a high frame rate and performs image processing instantaneously (at real time) on the captured images (performs image processing as real-time processing). The image processing apparatus 200 performs the above-described stereo matching processing as the image processing.

As shown in FIG. 11, the image processing apparatus 200 includes the image sensors 111, the data integration unit 113, and the GPU 114. These are basically similar to those described in the first embodiment, and thus detailed description thereof will be hereinafter omitted.

The strip data items read out from the respective image sensors 111 are supplied to the data integration unit 113. Specifically, in this case, data integration unit 113 integrates the strip data items on which the position correction is not performed, and supplies the GPU 114 with the strip data items.

The GPU 114 includes a stereo matching processor 211 and a position correction unit 212 as functional blocks.

The stereo matching processor 211 performs the stereo matching processing using the integration data items supplied from the data integration unit 113. The integration data items form the stereo images having the mutual parallaxes using the plurality of strip data items acquired in the same exposure period, detailed description of which is described later. The stereo matching processor 211 generates the depth maps that map the information about the depth of each position in the image capturing ranges.

The position correction unit 212 corrects the displacements among the captured images caused by the positional differences of the respective image sensors 111 for the depth maps. The GPU 114 outputs the position-corrected depth maps. For example, the image processing apparatus 100 further includes a 3D image generation unit 221. The GPU 114 supplies the 3D image generation unit 221 with the position-corrected depth maps.

The 3D image generation unit 221 generates 3D images, i.e., stereoscopic images using the supplied depth maps.
<Arrangement Example of Image Sensor>
The arrangement of the image sensors 111 is arbitrary similar to that of the first embodiment. In the following description, the image sensors 111 are arranged in one line in the horizontal direction similar to those of FIG. 2.
   <Flow of Image Processing>
An example of a flow of the image processing executed by the image processing apparatus 200 of FIG. 11 will be described with reference to a flowchart of FIG. 12. As necessary, it will be described with reference to FIG. 13 to FIG. 18.

Once the image processing apparatus 200 starts the image processing, each image sensor 111 captures images of an object at its own timing in Step S201.

The exposure periods (periods of exposure) (in other words, image capturing timings) of the respective image sensors 111 are controlled as an example of FIG. 13. Each arrow in FIG. 13 shows the exposure period of the corresponding Cam. In the example of FIG. 13, the exposure periods of the Cam0 and the Cam5 are the same, the exposure periods of the Cam1 and the Cam6 are the same, the exposure periods of the Cam2 and the Cam7 are the same, and the exposure periods of the Cam3, the Cam8, and the Cam4 are the same. Specifically, the timings of the exposure periods of the nine image sensors 111 are divided in four sets.

Accordingly, assuming that the frame rate of each image sensor 111 is 60 fps, the exposure periods of the respective sets are shifted by the time provided by dividing each exposure time ( 1/60 sec) by the number of sets (4) of the image sensors 111, i.e., 1/240 sec.

Thus, in the case of the second embodiment, some of the image sensors 111 have the same exposure period.

With reference to FIG. 12 again, in Step S202, each image sensor 111 reads out the strip data items of the captured images to the outside of the image sensor 111 at predetermined timings. In other words, the strip data items are read out from the respective image sensor 111 similar to the first embodiment. Specifically, the strip data items acquired in the same period are read out by the respective image sensors 111 at the same timing.

However, as described above, in the case of the second embodiment, since some of the image sensors 111 have the same exposure period, some of the strip data items read out from the respective image sensors 111 have the same image data items of the line at the same position.

An example of reading out the strip data items at the predetermined timing t0 is shown in FIG. 14. In FIG. 14, a captured image 251-0 to a captured image 251-8 shown by dotted lines respectively represent the periods during which the image data items of the one frame of the captured images are read from the respective image sensors 111 (Cam0 to Cam8). In the following, in a case where there is no need to distinguish the captured image 251-0 to the captured image 251-8 from one another, it may be collectively referred to as captured images 251.

As shown in FIG. 14, the read-out periods of the one frame of captured images 251 from the Cam0 to the Cam3 are shifted by δt (in the example of FIG. 13, δt= 1/240 sec) from one another. In addition, the read-out periods of the one frame of captured images 251 from the Cam5 to the Cam8 are shifted by δt (in the example of FIG. 13, δt= 1/240 sec) one another.

As described above, since the exposure periods of the Cam0 and the Cam5 are the same, the read-out period of the captured image 251-0 and the read-out period of the captured image 251-5 from the Cam5 are the same. Similarly, the read-out periods of the captured image 251-1 and the captured image 251-6 are the same, the read-out periods of the captured image 251-2 and the captured image 251-7 are the same, and the read-out periods of the captured image 251-3 and the captured image 251-8 are the same, respectively. Note that the read-out period of the captured image 251-4 is the same as the read-out periods of the captured image 251-3 and the captured image 251-8.

At the predetermined timing to, it is assumed that a strip data item 252-0 to a strip data item 252-8 are read out from the respective image sensors 111. In the following, in a case where there is no need to distinguish the strip data item 252-0 to the strip data item 252-8 from one another, it may be collectively referred to as strip data items 252.

Since the respective strip data items 252 are data items acquired in the same period, the positions of the strip data items 252 with respect to the respective captured images 251 are as shown in FIG. 14. In other words, data items of lines different from each other are acquired at the same timing from an image sensor 111-0 to an image sensor 111-3. Similarly, data items of lines different from each other are acquired from an image sensor 111-5 to an image sensor 111-8.

In other words, the strip data items of the same line are acquired from the image sensor 111-0 and the image sensor 111-5. Similarly, the strip data items of the same line are acquired from the image sensor 111-1 and the image sensor 111-6, the image sensor 111-2 and the image sensor 111-7, the image sensor 111-3, the image sensor 111-4, and the image sensor 111-8, respectively.

Since the strip data items of the same line are acquired from the image sensors 111 different from each other, the strip data items have mutual parallaxes. In other words, the second embodiment provides the strip data items of the stereo images of the plurality of images having mutual parallaxes.

An example of reading out the strip data items at the next timing t0+δt is shown in FIG. 5. At the timing t0+δt (FIG. 15), the next strip data items are read out. Specifically, the image data items acquired during the period from the timing t0 for the time δt are read out as the strip data items. In the case of the Cam0, since the last strip data item of the frame is read out at the timing t0 (FIG. 14), the first strip data item 253-0 of the next frame of the captured image 251-10 is read out at the timing t0+δt (FIG. 15). Similarly, in the case of the Cam5, since the last strip data item of the frame is read out at the timing t0 (FIG. 14), the first strip data item 253-0 of the next frame of the captured image 251-15 is read out at the timing t0+δt (FIG. 15).

Also in the case of the timing t0+δt, the strip data items are read out similar to the case of the timing t0 (FIG. 14). In other words, the second embodiment provides the strip data items of the stereo images having mutual parallaxes.

With reference to FIG. 12 again, in Step S203, the data integration unit 113 integrates a strip data item group acquired by the respective image sensors 111 at the same timing (i.e., acquired by the processing in Step S202).

An example of integrating the strip data items read out at the predetermined timing t0 is shown in FIG. 16. For example, as shown in A of FIG. 16, images of an automobile being an object 261 are captured using the respective image sensors 111 at the timing t0. As shown in B of FIG. 16, a captured image 262-1 to a captured image 262-M are acquired by M image sensors 111 (where M is a natural number) different from each other. In the following, in a case where there is no need to distinguish the captured image 262-1 to the captured image 262-6 from one another, it may be collectively referred to as captured images 262.

In addition, at the timing to, a strip data item 263-1 to a strip data item 263-M are acquired from these image sensors 111. In the following, in a case where there is no need to distinguish the strip data item 263-1 to the strip data item 263-M from one another, it may be collectively referred to as strip data items 263.

The data integration unit 113 arranges the respective strip data items 263 in an arbitrary order to generate a set of integration data items 264. For example, as an example of FIG. 16, the strip data items 263 of the stereo images may be arranged adjacently.

Also, in this case, as no position correction is performed, image displacements and the like are generated in the respective strip data items of the integration data items 264 as an example of FIG. 16, and their positions are shifted from one another.

In addition, an example of integrating the strip data items read out at the next timing t0+δt is shown in FIG. 17. For example, as shown in A of FIG. 17, images of the object 181 of the automobile are captured using the respective image sensors 111 at the timing t0+δt. As shown in B of FIG. 17, a captured image 265-1 to a captured image 265-6 are acquired by M image sensors 111 different from each other. In the following, in a case where there is no need to distinguish from the captured image 265-1 to the captured image 265-6 from one another, it may be collectively referred to as captured images 265.

In addition, at the timing t0+δt, a strip data item 266-1 to a strip data item 266-6 are acquired from these image sensors 111. In the following, in a case where there is no need to distinguish the strip data item 266-1 to the strip data item 266-6 from one another, it may be collectively referred to as strip data items 266.

Also in this case, the data integration unit 113 arranges the respective strip data items 266 in any order to generate a set of integration data items 267. For example, as an example of FIG. 17, the strip data items 266 of the stereo images may be arranged adjacently.

Also, in this case, as no position correction is performed, image displacements and the like are generated in the respective strip data items of the integration data items 267 as an example of FIG. 17, and their positions are shifted from one another.

In the examples described with reference to FIG. 13 to FIG. 15, the integration data items 264 and the integration data items 267 are stereo image data items for one frame, respectively. In other words, since the strip data items are integrated by the data integration unit 113, the integration data items (one frame of image data items) are acquired for each period δt.

With reference to FIG. 12 again, in Step S204, the data integration unit 113 transmits the integration data items to the GPU 114.

In other words, the GPU 114 acquires a set of captured images each having a frame rate (in the examples of FIG. 13 to FIG. 15, 240 fps) higher than the frame rate (standard frame rate) of each image sensor 111.

Accordingly, also in the second embodiment, the GPU 114 may perform the desired image processing using the respective integration data items at the processing speed to match with the high frame rate. Specifically, since the GPU 114 has no need to perform complex processing including aligning and processing a plurality of image data items supplied in parallel and processing a plurality of image data items in parallel, increases of the time lag and the power consumption are inhibited. Also, an increase of development and production costs is inhibited.

In Step S205, the stereo matching processor 211 of the GPU 114 performs the stereo matching processing using the stereo images included in the integration data items as the image processing using the supplied integration data items.

By the stereo matching processing, depth maps 271 shown by A of FIG. 18 to F of FIG. 18 are generated, for example. The depth maps 271 each indicates a distance (depth) to the object at each position in the image capturing ranges by brightness. Specifically, the depth maps with a high frame rate are generated. Thus, the image processing apparatus 200 can determine more precisely the distance to the object-being-moved at a high speed.

With reference to FIG. 12 again, in Step S206, the position correction of the depth maps is performed. Note that the position correction of the depth maps is performed using the stereo images, and it is thus possible to process the depth maps for the respective strip data items in the frames. Therefore, it is not necessarily to perform the position correction before the stereo matching processing.

In Step S207, the GPU 114 outputs the resultant depth maps to the 3D image generation unit 221. The 3D image generation unit 221 generates stereoscopic images (3D images) using the depth maps.

After each processing is performed as described above, the image processing is ended. Note that the above-described each processing in Step S201 to Step S207 is repeated for each period δt. Specifically, each processing is executed in parallel. After the image capture is ended, each processing is ended.

As described above, the image processing apparatus 200 can realize the image capture with a high frame rate by using the plurality of inexpensive image sensors 111 with low power consumption and a low frame rate (standard frame rate). Accordingly, the image processing apparatus 200 can realize the image capture with a high frame rate while increases of the costs and the power consumption are inhibited. In addition, by integrating strip data items acquired at the same timing as described above, the image processing apparatus 200 can reduce the transmission delay of the image data items while increases of the costs and the power consumption are inhibited. In this manner, the image processing apparatus 200 can realize the instantaneous image processing of the image data items while increases of the costs and the power consumption are inhibited.

### Other Examples

Note that the present technology is not limited to the above-described examples. For example, the configuration of the apparatus to which the present technology is applied is not limited to the configuration of the image processing apparatus 200 of FIG. 11. It is only necessary for an apparatus to which the present technology is applied to have the data integration unit 113 of FIG. 11, and other configurations may be configured as other apparatuses. Also, one image processing apparatus 231 may include the data integration unit 113 and the GPU 114, for example. In this case, one image capturing apparatus 232 may include the image sensors 111. Alternatively, one apparatus may include the respective image sensors 111. Also, one image capturing apparatus 233 may include the image processing apparatus 231 and the image capturing apparatus 232.

In addition, for example, the data integration unit 113 may integrate the plurality of partial images acquired in the same period by the plurality of image sensors 111 of which the exposure periods are the same. In other words, the data integration unit 113 may integrate the plurality of partial images located at the same position of the captured images.

### 3. Third Embodiment

### <Computer>

The series of processes described above can be performed by hardware or software. When the series of processes are performed by software, programs that configure the software are installed into a computer. Here, the computer includes a computer incorporated in dedicated hardware, for example, a general-purpose personal computer capable of implementing various functions by installing various programs, and the like.

FIG. 19 is a block diagram showing an example of the structure of hardware of a computer which executes the series of processes described above by a program.

In a computer 800 of FIG. 19, a CPU (Central Processing Unit) 801, a ROM (Read Only Memory) 802, and a RAM (Random Access Memory) 803 are connected with one another via a bus 804.

To the bus 804, an input and output interface 810 is further connected. To the input and output interface 810, an input unit 8110, an output unit 812, a storage unit 813, a communication unit 814, and a drive 815 are connected.

The input unit 811 may include a keyboard, a mouse, a microphone, or the like. The output unit 812 may include a display, a speaker, or the like. The storage unit 813 may include a hard disk, a nonvolatile memory, or the like. The communication unit 109 may include a network interface or the like. The drive 815 drives a removable medium 821 such as a magnetic disk, an optical disk, a magneto-optical disk, and a semiconductor memory.

In the computer configured as described above, the CPU 801 loads a program stored in the storage unit 813 via the input and output interface 810 and the bus 804 into the RAM 803, for example, and executes the program, thereby performing the series of processes described above. Data necessary for execution of a variety of processing by the CPU 801 and the like are appropriately stored in the RAM 803.

The program executed by the computer (CPU 801) can be recorded in the removable medium 821 and provided, for example as a package medium or the like. In this case, the program can be installed into the storage unit 813 via the input and output interface 810 by loading the removable medium 821 to the drive 815.

Further, the program can be provided via a wired or wireless transmission medium such as a local area network, the Internet, and digital satellite broadcasting. In this case, the program can be received at the communication unit 814, and installed into the storage unit 813.

In addition, the program can be installed in advance into the ROM 102 or the storage unit 108.

Note that the program executed by the computer may be a program in which process steps are executed in a time series along the order described in the specification, or may be a program in which process steps are executed in parallel, or at a necessary timing when called.

It should be noted that, in the present specification, the steps for illustrating the series of processes described above include not only processes that are performed in time series in the described order, but also processes that are executed in parallel or individually, without being necessarily processed in time series.

Also, the processing in each Step as described above can be executed by each apparatus as described above or by arbitrary apparatus other than the above-described apparatuses. In this case, the apparatus executing the processing may have the functions (such as functional blocks) necessary for the execution of the processing. In addition, the information necessary for the processing may be transmitted to the apparatus, as appropriate.

Further, in the present specification, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or a plurality of modules within a single casing.

Further, the configuration described above as one device (or processing unit) may be divided into a plurality of devices (or processing units). Vice versa, the configuration described above as a plurality of devices (or processing units) may be combined into one device (or processing unit). Further, it should be understood that a configuration other than the configuration described above may be added to the configuration of each device (or each processing unit). Further, where a configuration or an operation of an entire system is substantially the same, a part of the configuration of any device (or processing unit) may be included in a configuration of another device (or another processing unit). In other words, the present technology is not limited to the embodiments described above and various changes can be made without departing from the gist of the present technology.

While the preferred embodiments of the present disclosure have been described in detail with reference to the accompanying drawings, the disclosure is not limited to such examples. It is apparent that various variations or modifications can be conceived by those skilled in the art in the gist of technical ideas of the claims, and it is understood that the variations or modifications are within to the technical scope of the present disclosure.

For example, the present technology may take a configuration of cloud computing that shares one function by a plurality of devices via a network and performs co-processing.

In addition, the respective steps described in the flowcharts described above may be executed by one apparatus, or may also be executed by sharing the steps with a plurality of apparatuses.

Further, in a case where one step includes a plurality of processes, the plurality of processes included in one step may be executed by one apparatus, or may also be executed by sharing the steps with a plurality of apparatuses.

In addition, the present technology is not limited thereto and can be carried out as any kind of configurations mounted on a device that configures the device and the system, for example, a processor as a system large scale integration (LSI), a module including a plurality of processors, a unit including a plurality of modules, and a set having another function added to the unit (that is, a configuration of a part of the device).

The present technology can be applied to a variety of technologies including signal processing, image processing, coding and decoding, measuring, calculation control, drive control, display, and the like. For example, the present technology can be applied to content creation, analysis of sports scene, medical equipment control, MEMS (Micro Electro Mechanical Systems) for control of a field of vision of an electron microscope control, drive control of a robot, control of FA (factory automation) device of a production line or the like, object tracking in surveillance camera, 3D measurement, a crash test, operation control such as an automobile or airplane, an intelligent transport systems (ITS (Intelligent Transport systems) visual inspection, a user interface, augmented reality (AR), digital archives, life sciences and the like.

The present technology may also have the following configurations.

(1) An image processing apparatus, including:
an image integration unit that integrates respective partial images of a plurality of captured images acquired by image capturing units different from each other and generates one composited image.
   (2) The image processing apparatus according to (1), in which
the image integration unit integrates the partial images acquired by the image capturing units, the partial images being acquired in the same period shorter than an exposure time for one frame of the captured images.
   (3) The image processing apparatus according to (2), in which
the image integration unit integrates the partial images for each time within the period.
   (4) The image processing apparatus according to (2) or (3), in which
respective exposure periods of the image capturing units are shifted from one another.
   (5) The image processing apparatus according to (4), in which
the respective exposure periods of the image capturing units are shifted from one another for each predetermined time.
   (6) The image processing apparatus according to (5), in which
the predetermined time is shorter than the exposure time for one frame of the captured images.
   (7) The image processing apparatus according to (6), in which
a length of the period of acquiring the partial images is the predetermined time.
   (8) The image processing apparatus according to (7), in which
the predetermined time is a time provided by dividing the exposure time for one frame of the captured images by the number of the partial images to be integrated by the image integration unit.
   (9) The image processing apparatus according to any of (4) to (8), in which
the image integration unit integrates the plurality of partial images located at positions different from each other of the captured images.
   (10) The image processing apparatus according to any of (2) to (9), in which
the respective exposure periods of the image capturing units are the same period.
   (11) The image processing apparatus according to (10), in which
the image integration unit integrates the plurality of partial images located at the same position of the captured images.
   (12) The image processing apparatus according to any of (2) to (11), in which
the exposure periods of some of the image capturing units are the same, and the exposure periods of the others are shifted from one another.
   (13) The image processing apparatus according to (12), in which
the image integration unit integrates the plurality of partial images located at the same position of the captured images with the partial image located at a position of the captured images, the position being different from the position of any of the plurality of partial images.
   (14) The image processing apparatus according to any of (1) to (13), further including:
a position correction unit that corrects positions of the partial images in accordance with the positions of the image capturing units that acquire the partial images.
   (15) The image processing apparatus according to any of (1) to (14), further including:
a chasing processor that performs chasing of a focused object in the composited image using the composited image generated by the image integration unit.
   (16) The image processing apparatus according to (15), further including:
a processing execution unit that performs processing on control of an actuator unit that performs a predetermined physical motion using information on a chasing result of the focused object acquired by the chasing processor. according to.
   (17) The image processing apparatus according to any of (1) to (16), further including:
a depth information generation unit that generates depth information about a depth of an object in the composited image using the composited image generated by the image integration unit.
   (18) The image processing apparatus according to (17), further including:
a position correction unit that performs position correction on the depth information generated by the depth information generation unit in accordance with the position of the image capturing unit that acquires the depth information.
   (19) The image processing apparatus according to according to any of (1) to (18), further including:
the plurality of image capturing units.
   (20) An image processing method, including:
integrating respective partial images of a plurality of captured images acquired by image capturing units different from each other; and generating one composited image.

### REFERENCE SIGNS LIST

100 image processing apparatus

111 image sensor
112 position correction unit
113 data integration unit

### 114 GPU

121 tracking processor
131 control unit
132 actuator
141 image processing apparatus
142 image capturing apparatus
143 image processing apparatus
144 control apparatus
171 captured image
172 and 173 strip data item
181 object
182 captured images
183 strip data item
184 integration data item
185 captured image
186 strip data item
187 integration data item
191 ball
195 robot
200 image processing apparatus
211 stereo matching processor
212 position correction unit
221 3D image generation unit
231 image processing apparatus
232 image capturing apparatus
233 image processing apparatus
251 captured image
252 and 253 strip data item
261 object
262 captured image
263 strip data item
264 integration data item
265 captured image
266 strip data item
267 integration data item
271 depth map
800 computer

1. An image processing apparatus, comprising:
an image integration unit that integrates respective partial images of a plurality of captured images acquired by image capturing units different from each other and generates one composited image.

2. The image processing apparatus according to claim 1, wherein
the image integration unit integrates the partial images acquired by the image capturing units, the partial images being acquired in the same period shorter than an exposure time for one frame of the captured images.

3. The image processing apparatus according to claim 2, wherein
the image integration unit integrates the partial images for each time within the period.

4. The image processing apparatus according to claim 2, wherein
respective exposure periods of the image capturing units are shifted from one another.

5. The image processing apparatus according to claim 4, wherein
the respective exposure periods of the image capturing units are shifted from one another for each predetermined time.

6. The image processing apparatus according to claim 5, wherein
the predetermined time is shorter than the exposure time for one frame of the captured images.

7. The image processing apparatus according to claim 6, wherein
a length of the period of acquiring the partial images is the predetermined time.

8. The image processing apparatus according to claim 7, wherein
the predetermined time is a time provided by dividing the exposure time for one frame of the captured images by the number of the partial images to be integrated by the image integration unit.

9. The image processing apparatus according to claim 4, wherein
the image integration unit integrates the plurality of partial images located at positions different from each other of the captured images.

10. The image processing apparatus according to claim 2, wherein
the respective exposure periods of the image capturing units are the same period.

11. The image processing apparatus according to claim 10, wherein
the image integration unit integrates the plurality of partial images located at the same position of the captured images.

12. The image processing apparatus according to claim 2, wherein
the exposure periods of some of the image capturing units are the same, and the exposure periods of the others are shifted from one another.

13. The image processing apparatus according to claim 12, wherein
the image integration unit integrates the plurality of partial images located at the same position of the captured images with the partial image located at a position of the captured images, the position being different from the position of any of the plurality of partial images.

14. The image processing apparatus according to claim 1, further comprising:
a position correction unit that corrects positions of the partial images in accordance with the positions of the image capturing units that acquire the partial images.

15. The image processing apparatus according to claim 1, further comprising:
a chasing processor that performs chasing of a focused object in the composited image using the composited image generated by the image integration unit.

16. The image processing apparatus according to claim 15, further comprising:
a processing execution unit that performs processing on control of an actuator unit that performs a predetermined physical motion using information on a chasing result of the focused object acquired by the chasing processor.

17. The image processing apparatus according to claim 1, further comprising:
a depth information generation unit that generates depth information about a depth of an object in the composited image using the composited image generated by the image integration unit.

18. The image processing apparatus according to claim 17, further comprising:
a position correction unit that performs position correction on the depth information generated by the depth information generation unit in accordance with the position of the image capturing unit that acquires the depth information.

19. The image processing apparatus according to claim 1, further comprising:
the plurality of image capturing units.

20. An image processing method, comprising:
integrating respective partial images of a plurality of captured images acquired by image capturing units different from each other; and generating one composited image.
